(19) United States
(12) Patent Application Publication
(10) Pub. No.: US 2019/0061162 A1
(43) Pub. Date: Feb. 28, 2019

(54) Robot System

(71) Applicant: Seiko Epson Corporation, Tokyo (JP)

(72) Inventor: Nobuhiro KARITO, Azumino (JP)

(21) Appl. No.: 16/109,849

(22) Filed: Aug. 23, 2018

(30) Foreign Application Priority Data
Aug. 24, 2017 (JP) 2017-160893

(51) Int. Cl. B25J 9/16

(52) U.S. Cl. CPC B25J 9/1697; B25J 9/1689; B25J 9/1664

(57) ABSTRACT

A robot system includes a robot and a network device, and in which the robot includes a first network controller including a first network terminal configured to connect to the network device and a second network controller including a second network terminal configured to connect to the network device and the same first network information is set in the first network controller and the second network controller.

### BACKGROUND

### 1. Technical Field

The present invention relates to a robot system.

### 2. Related Art

In the related art, there has been proposed a robot system that calculates a position and attitude of a work target using an image captured by an imaging device (camera) and causes a robot to perform predetermined work based on the calculated position and attitude. Such a robot system is configured to include an imaging device, an image processing device, a robot controller, and a robot. The image processing device recognizes the position and attitude of the work target by using the image captured by the imaging device. Then, based on the recognized position and attitude of each work target, the robot controller generates a command for positioning a hand mechanism included in the robot in an appropriate position and attitude and controls a gripping operation of the robot. In the robot system, the imaging device is connected to the image processing device, the robot controller is connected to the image processing device, and the robot is connected to the robot controller.

In JP-A-11-85235, matters that an image captured by a CCD camera (imaging device) is transferred to an image processing device are described.

However, in JP-A-11-85235, the image captured by the imaging device is transferred to the image processing device, but depending on the position and orientation where the image processing device is placed, a camera terminal is not installed at a position suitable for work, and there was a case where a length of a wiring connected to the imaging device was insufficient and the wiring cannot be connected (imaging cannot be performed) and a case where the wiring was forced to pass through a place where robot work was hindered.

### SUMMARY

An advantage of some aspects of the invention is to solve at least a part of the problems described above, and the invention can be implemented as the following forms or application examples.

### Application Example 1

A robot system according to this application example includes a robot and a network device, and in which the robot includes a first network controller including a first network terminal connectable to the network device and a second network controller including a second network terminal connectable to the network device and the same first network information is set in the first network controller and the second network controller.

According to this application example, the robot includes a network terminal to which the same first network information is set. With this, it is possible to connect the network device by selecting a network terminal at a position suitable for work. Furthermore, even if a network device is connected to any network terminal, it is possible to continue work without performing complicated resetting work of changing the first network information.

### Application Example 2

In the robot system according to the application example, it is preferable that the network device is a camera.

According to this application example, it is possible to connect the camera by selecting a network terminal at a position suitable for work. Furthermore, even if a camera is connected to any network terminal, it is possible to continue work without performing complicated resetting work of changing the network information.

### Application Example 3

In the robot system according to the application example, it is preferable that the robot system further includes a third network controller including a third network terminal connectable to the network device, and a fourth network controller including a fourth network terminal connectable to the network device, and the same second network information different from the first network information is set in the third network controller and the fourth network controller.

According to this application example, the robot includes a plurality of network terminals to which the same second network information is set. With this, it is possible to connect each of a plurality of network devices by selecting a network terminal at a position suitable for work. Furthermore, even if a network device is connected to any network terminal, it is possible to continue work without performing complicated resetting work of changing the second network information.

### Application Example 4

In the robot system according to the application example, it is preferable that the network device is a stereo camera.

According to this application example, it is possible to connect the stereo camera by selecting a network terminal at a position suitable for work. Furthermore, even if a stereo camera is connected to any network terminal, it is possible to continue work without performing complicated resetting work of changing the network information.

### Application Example 5

In the robot system according to the application example, it is preferable that the first network terminal and the third network terminal are disposed on a first surface of a casing of the robot and the second network terminal and the fourth network terminal are disposed on a second surface different from the first surface of the casing of the robot.

According to this application example, the first surface and the second surface different from the first surface include a plurality of network terminals, respectively. With this, it is possible to connect the network device by selecting the network terminal at the position of the first surface or the second surface suitable for work.

### BRIEF DESCRIPTION OF THE DRAWINGS

The invention will be described with reference to the accompanying drawings, wherein like numbers reference like elements.

FIG. 1 is a diagram illustrating an example of outer appearance of a robot system according to an embodiment.

FIG. 2 is a diagram for explaining details of each hand portion according to the embodiment.

FIG. 3 is a block diagram illustrating an example of a schematic configuration of a robot according to the embodiment.

FIG. 4 is a diagram illustrating an arrangement of camera terminals according to the embodiment.

FIG. 5 is a diagram illustrating specific network information of each network controller and each camera according to the embodiment.

### DESCRIPTION OF EXEMPLARY EMBODIMENTS

Hereinafter, an embodiment of the invention will be described with reference to the drawings. The drawings to be used is displayed by being enlarged or reduced as appropriate so as to make it possible for an explanation part to be in a recognizable state.

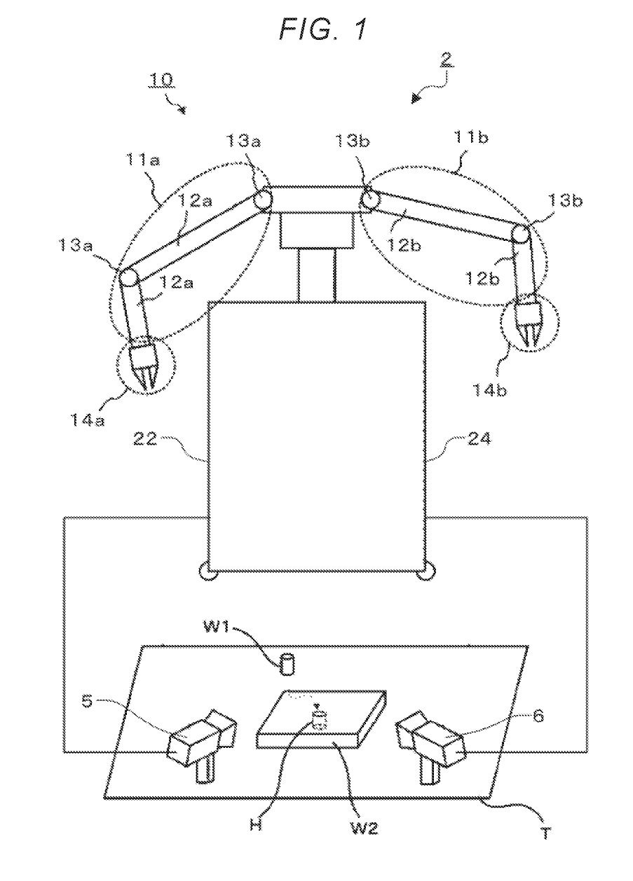

FIG. 1 is a diagram illustrating an example of outer appearance of a robot system according to the embodiment.

As illustrated in FIG. 1, a robot system 2 according to the embodiment includes a robot 10 and a first camera 5 and a second camera 6 as network devices. The robot 10 is a dual arm robot including a left arm portion 11a and a right arm portion 11b. The robot grips workpieces W1 and W2 and performs fitting work with a left hand portion 14a and a right hand portion 14b attached to tip ends of the left arm portion 11a and the right arm portion 11b, respectively.

Here, the left arm portion 11a functions as a left arm of the robot 10, and includes a plurality of links 12a and a plurality of joints (joints) 13a connecting the respective links 12a.

Each joint 13a rotatably connects the links 12a to each other or the body of the robot 10 and the link 12a. For that reason, the left hand portion 14a attached to the tip end portion of the left arm portion 11a can be freely moved (but within a predetermined range) and can also be directed in a free direction, by driving the joints 13a in conjunction with each other.

The right arm portion 11b functions as a right arm of the robot 10, and includes a plurality of links 12b and a plurality of joints (joints) 13b connecting the respective links 12b.

Similar to the left arm portion 11a, each joint 13b of the right arm portion 11b rotatably connects the links 12b to each other or the body of the robot 10 and the link 12b. For that reason, the right hand portion 14b attached to the tip end portion of the right arm portion 11b can be freely moved (but within a predetermined range) and can also be directed in a free direction, by driving the joints 13b in conjunction with each other.

In FIG. 1, an example of a two-axis arm is illustrated, but is not limited to the illustrated arm. For example, the number of axes (the number of joints) may be further increased. Also, shapes of the links 12a and 12b, the left hand portion 14a, and the right hand portion 14b are not limited to the illustrated shapes. The left arm portion 11a and the right arm portion 11b and the left hand portion 14a and the right hand portion 14b are collectively referred to as a “gripping device”.

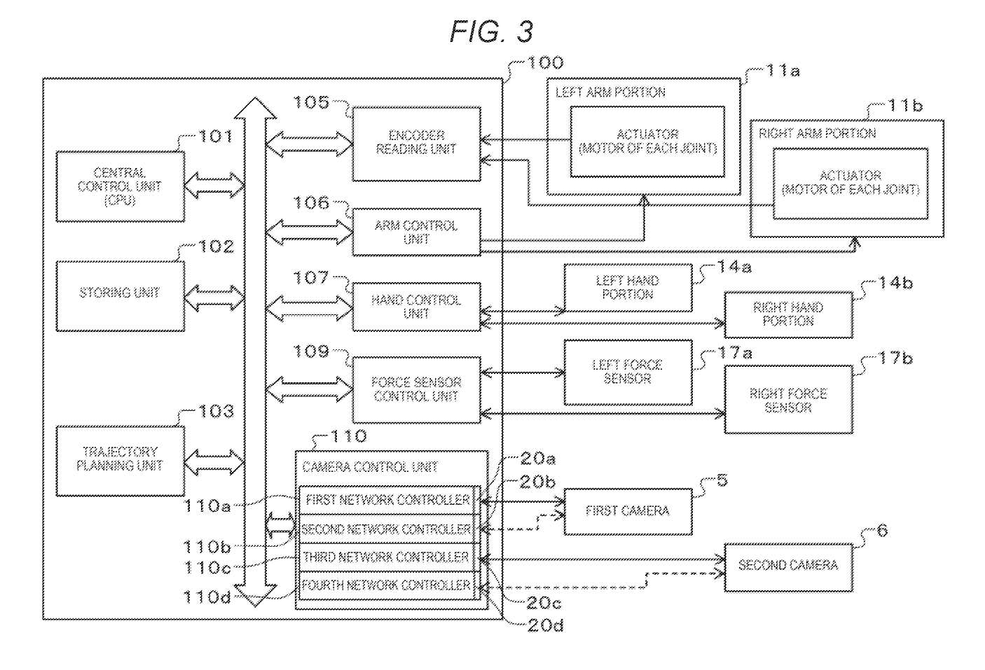

The robot 10 is communicably connected to the first camera 5 and the second camera 6. The first camera 5 and the second camera 6 capture an image of a work area (for example, a three-dimensional space in which work can be done by a movable unit on a work table T) of the robot 10, and generate image data. In the example of FIG. 1, two first cameras 5 and two second cameras 6 are installed on the worktable T at different angles. As the first camera 5 and the second camera 6, for example, a visible light camera, an infrared camera or the like can be adopted. Images captured by the first camera 5 and the second camera 6 are input to a control unit 100 (see FIG. 3).

Further, for example, installation positions of the first camera 5 and the second camera 6 are not particularly limited, and may be installed on a ceiling or a wall. Also, instead of or in addition to the first camera 5 and the second camera 6, a camera may be provided at the tip portion, the body portion, the head portion, or the like of the left arm portion 11a and the right arm portion 11b of the robot 10.

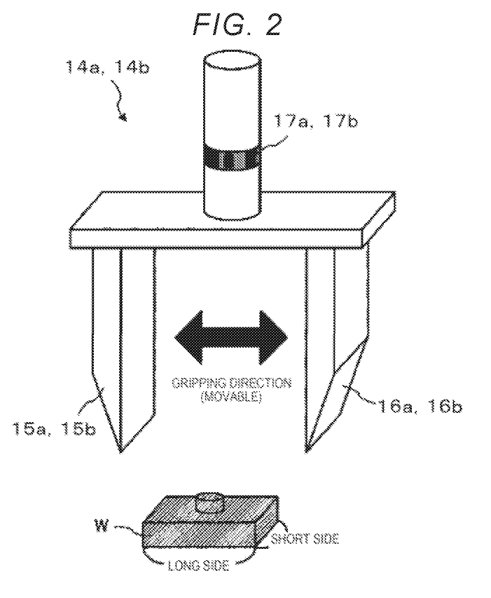

FIG. 2 is a diagram for explaining details of the left hand portion 14a and the right hand portion 14b according to the embodiment.

As illustrated in FIG. 2, the left hand portion 14a and the right hand portion 14b according to the embodiment include first fingers 15a and 15b, second fingers 16a and 16b, a left force sensor 17a, and a right force sensor 17b. The left hand portion 14a and the right hand portion 14b can grasp the workpiece W by moving the first fingers 15a and 15b and the second fingers 16a and 16b in the illustrated gripping direction.

The left hand portion 14a and the right hand portion 14b include a left force sensor 17a and a right force sensor 17b. The left force sensor 17a and the right force sensor 17b are force sensors of at least one axis or more (for example, six axes), and can detect a force (for example, force to push the workpiece W in the fitting direction) acting on the workpiece W and the moment of a force.

Meanwhile, the robot 10 including the left arm portion 11a and the right arm portion 11b and the left hand portion 14a and the right hand portion 14b as described above is controlled by the control unit 100. Although not illustrated in FIGS. 1 and 2, the control unit 100 may be built in the main body of the robot 10 or may be provided at a position where the robot 10 can be controlled by remote control.

FIG. 3 is a block diagram illustrating an example of a schematic configuration of the robot 10 according to the embodiment.

As illustrated in FIG. 3, the robot 10 according to the embodiment includes the control unit 100, the left arm portion 11a and the right arm portion 11b, the left hand portion 14a and the right hand portion 14b, the left force sensor 17a and the right force sensor 17b, and the first camera 5 and the second camera 6.

Although not described in FIGS. 1 and 2, each joint 13a included in the left arm portion 11a is provided with an actuator (motor) for driving each joint 13a. Similarly, each joint 13b included in the right arm portion 11b is also provided with an actuator (motor) for driving each joint 13b.

The first finger 15a and the second finger 16a included in the left hand portion 14a are also provided with actuators (motors) for driving the first finger 15a and the second finger 16a. Similarly, the first finger 15b and the second finger 16b included in the right hand portion 14b are also provided with actuators (motors) for driving the first finger 15b and the second finger 16b.

On the other hand, the control unit 100 includes a central control unit 101, a storing unit 102, a trajectory planning unit 103, an encoder reading unit 105, an arm control unit 106, a hand control unit 107, a force sensor control unit 109, and a camera control unit 110.

The control unit 100 is communicably connected to the robot 10, the first camera 5, and the second camera 6. The control unit 100 controls the robot 10 in its entirety. The robot 10 operates according to a control signal from the control unit 100 to perform work. Although the work content of the robot 10 is not particularly limited, for example, work of fitting a workpiece W1 on a work table T into a hole H of a workpiece W2, and the like are conceivable. The workpiece can be called a work target.

Here, the central control unit 101 comprehensively controls the storing unit 102, the trajectory planning unit 103, the encoder reading unit 105, the arm control unit 106, the hand control unit 107, the force sensor control unit 109, and the camera control unit 110 that are included in the control unit 100. The central control unit 101 gives position information of the left arm portion 11a and the right arm portion 11b and position information of the workpieces W, W1, and W2 to the trajectory planning unit 103, determines a trajectory, and then sends a command according to the trajectory to the left arm portion 11a and the right arm portion 11b via the arm control unit 106, and operates the left arm portion 11a and the right arm portion 11b, thereby performing work.

The storing unit 102 stores data necessary for various calculations, data (such as “shape data”) representing the shape of the workpieces W, W1, and W2, and the program for controlling the operation (for example, fitting operation) of the robot 10, and the like. For example, the storing unit 102 is configured with a volatile memory such as a DDR-SDRAM, a nonvolatile memory such as a flash memory, or the like.

A trajectory planning unit 103 performs trajectory planning of a predetermined point for the robot 10. The predetermined point may be TCP (a tool center point (TCP), for example. Information on the trajectory obtained by the trajectory planning unit 103 is used as information for controlling the robot 10.

An encoder reading unit 105 reads encoder values of the actuators provided on the joints 13a and 13b of the left arm portion 11a and the right arm portion 11b. Although not illustrated, the encoder reading unit 105 can also read the encoder values of the actuators provided in the left hand portion 14a and the right hand portion 14b. Such encoder values are used for ascertaining the position, moving direction, moving amount, speed, acceleration, and the like of the left arm portion 11a and the right arm portion 11b, the left hand portion 14a, and the right hand portion 14b.

The arm control unit 106 controls the left arm portion 11a and the right arm portion 11b. For example, the arm control unit 106 drives the actuators provided on the joints 13a and 13b of the left arm portion 11a and the right arm portion 11b to control (output an instruction) the left hand portion 14a and the right hand portion 14b, so that the left hand portion 14a and the right hand portion 14b are located at a position, directed toward a direction, moved at a speed suitable for the fitting work of the workpieces W, W1, and W2.

The hand control unit 107 controls the left hand portion 14a and the right hand portion 14b. For example, the hand control unit 107 drives the actuators provided on the first fingers 15a and 15b and the second fingers 16a and 16b of the left hand portion 14a and the right hand portion 14b to perform control (output an instruction) such as control to sandwich (that is, grip) the workpieces W, W1, and W2 between the first fingers 15a and 15b and the second fingers 16a and 16b, control to release the workpieces W, W1, and W2, and the like.

The force sensor control unit 109 controls the left force sensor 17a provided in the left hand portion 14a and the right force sensor 17b provided in the right hand portion 14b. For example, the force sensor control unit 109 acquires the force (force acting on the workpieces W, W1, and W2) and the moment of force detected by the left force sensor 17a and the right force sensor 17b.

The camera control unit 110 includes a first network controller 110a and a second network controller 110b. The first network controller 110a includes a first camera terminal 20a as a first network terminal connectable to the first camera 5. The second network controller 110b includes a second camera terminal 20b as a second network terminal connectable with the first camera 5. The same first network information is set in the first network controller 110a and the second network controller 110b. By doing as described above, the robot 10 includes the first camera terminal 20a and the second camera terminal 20b to which the same first network information is set. With this, it is possible to connect the first camera 5 by selecting either the first camera terminal 20a or the second camera terminal 20b at a position suitable for work. Furthermore, even in a case where the first camera 5 is connected to either the first camera terminal 20a or the second camera terminal 20b, it is possible to continue work without performing complicated work of setting the first network information on the network controllers (first network controller 110a and second network controller 110b) to which the first camera 5 is connected.

The camera control unit 110 includes a third network controller 110c and a fourth network controller 110d. The third network controller 110c includes a third camera terminal 20c as a third network terminal connectable to the second camera 6. The fourth network controller 110d includes a fourth camera terminal 20d as a fourth network terminal connectable to the second camera 6. The same second network information different from the first network information is set in the third network controller 110c and the fourth network controller 110d. By doing as described above, the robot 10 includes the third camera terminal 20c and the fourth camera terminal 20d in which the same second network information is set. With this, it is possible to select either the third camera terminal 20c or the fourth camera terminal 20d at a position suitable for work and connect the second camera 6. Furthermore, even in a case where the second camera 6 is connected to either the third camera terminal 20c or the fourth camera terminal 20d, it is possible to continue work without performing complicated work of setting the second network information on the network controllers (first network controller 110a and second network controller 110b) to which the second camera 6 is connected.

The camera control unit 110 controls the first camera 5 and the second camera 6. The camera control unit 110 controls imaging by the first camera 5 and the second camera 6. The camera control unit 110 transmits a control signal to the first camera 5 and the second camera 6 via a cable by the network controller so as to control the first camera 5 and the second camera 6. The camera control unit 110 instructs the first and second cameras 5 and 6 to acquire images, and the first camera 5 and the second camera 6 capture images.

The first camera 5 and the second camera 6 transmit image data to the control unit 100 via the camera control unit 110. The control unit 100 recognizes a camera image in an image processing unit (not illustrated) and calculates positional information of the workpiece W, W1, and W2 and the like.

The first camera 5 and the second camera 6 may be a left camera and a right camera that are stereo cameras, respectively. In carrying out work, the installation positions of the first camera 5 (left camera) and the second camera 6 (right camera) depend on the work content, and there is a case where it is desired to stereographically capture an image of the work target on the right side when viewed from the robot 10 or a case where it is desired to stereographically capture an image of the work target on the left side when viewed from the robot 10.

In the embodiment, the first camera terminal 20a, the second camera terminal 20b, the third camera terminal 20c, and the fourth camera terminal 20d that can connect the first camera 5 and the second camera are included in the robot 10. The first camera terminal 20a, the second camera terminal 20b, the third camera terminal 20c, and the fourth camera terminal 20d of this embodiment are arranged so as to be able to select a position convenient for work. According to this, it is possible to select either the first camera terminal 20a or the second camera terminal 20b at a position suitable for work and connect the first camera 5. It is possible to select either the third camera terminal 20c or the fourth camera terminal 20d at a position suitable for work and connect the second camera 6. Furthermore, even in a case where the first camera 5 is connected to either the first camera terminal 20a or the second camera terminal 20b, it is possible to continue work without performing complicated work of setting the first network information in the network controller (first network controller 110a or second network controller 110b) to which the second camera 6 is connected. Even in a case where the second camera 6 is connected to either the third camera terminal 20c or the fourth camera terminal 20d, it is possible to continue work without performing complicated work of setting the second network information in the network controller (first network controller 110a or second network controller 110b) to which the second camera 6 is connected.

The main constituent elements of the control unit 100 can be implemented by a general computer including a CPU which is an operation device, a ROM in which a program and the like are recorded, a RAM which functions as a main memory and temporarily stores data and the like, interface for controlling input and output control with the host and the like, and a system bus serving as a communication path between the respective constituent elements. The main constituent elements may be configured to include an application specific integrated circuit (ASIC) designed for exclusively performing specific processing or may be configured by the ASIC.

The robot 10 to which the embodiment is applied has the configuration as described above. However, in this configuration, the main configuration of the invention of the present application is explained in explaining the features of the invention of the present application, and the invention is not limited to the configuration described above. Also, other configurations of a general double arm robot are not excluded. The robot 10 may be a robot including many robot arms, hands, and fingers.

The respective constituent elements described above are classified according to main processing contents in order to make the configuration of the control unit 100 easy to understand. The invention of the present application is not limited by the names of the constituent elements and manner of classification of the constituent elements. The configuration of the control unit 100 can also be classified into more constituent elements according to processing contents. The configuration is also classified such that one constituent performs more processing. Processing of each constituent element may be executed by one piece of hardware or may be executed by a plurality of pieces of hardware.

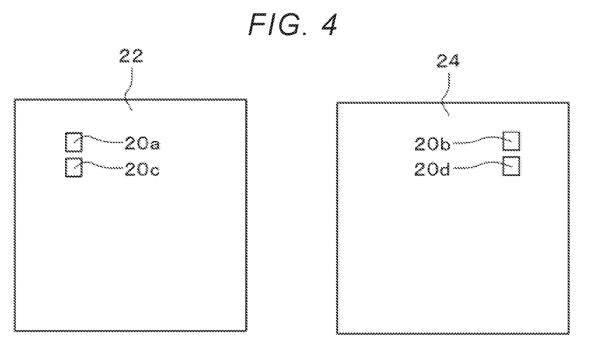

FIG. 4 is a diagram illustrating an arrangement of the first camera terminal 20a, the second camera terminal 20b, the third camera terminal 20c, and the fourth camera terminal 20d according to the embodiment.

As illustrated in FIG. 4, the robot 10 according to the embodiment includes the first camera terminal 20a, the second camera terminal 20b, the third camera terminal 20c, and the fourth camera terminal 20d that can connect the first camera 5 and the second camera 6. The first camera terminal 20a, the second camera terminal 20b, the third camera terminal 20c, and the fourth camera terminal 20d are arranged so as to be able to select a position convenient for work.

The first camera terminal 20a and the third camera terminal 20c are arranged on a left side surface (first surface) 22 of the casing of the robot 10 and the second camera terminal 20b and the fourth camera terminal 20d are arranged on a right side surface (second surface) 24 different from the left side surface 22 of the casing of the robot 10. According to this, the first camera terminal 20a and the third camera terminal 20c are provided on the left side surface 22. The second camera terminal 20b and the fourth camera terminal 20d are provided on the right side surface 24. With this, it is possible to connect the first camera 5 by selecting the first camera terminal 20a or the second camera terminal 20b at a position suitable for work. It is possible to connect the second camera 6 by selecting the third camera terminal 20c or the fourth camera terminal 20d at a position suitable for work.

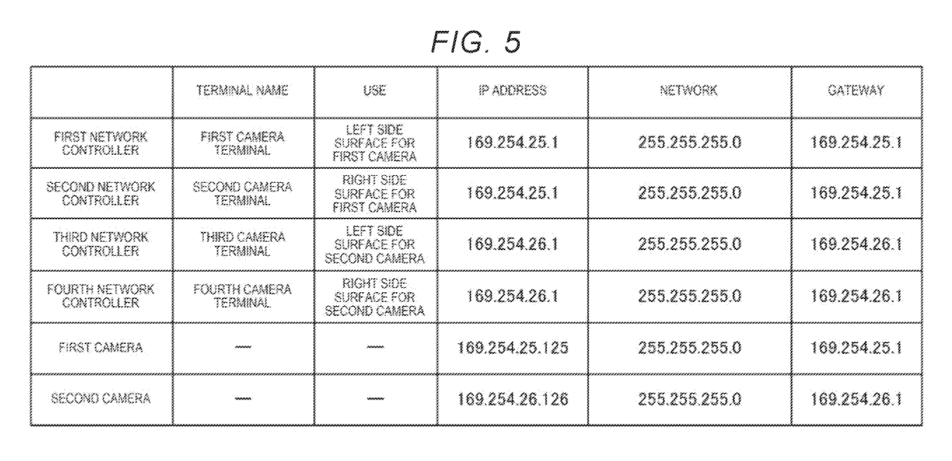

FIG. 5 is a diagram illustrates specific network information of the first network controller 110a, the second network controller 110b, the third network controller 110c, the fourth network controller 110d, the first camera 5, and the second camera 6 according to the embodiment. The same first network information is set in the first network controller 110a and the second network controller 110b. The same second network information is set in the third network controller 110c and the fourth network controller 110d. For example, as illustrated in FIG. 5, the IP address in the first network information is “169.254.25.1”. The IP address of the second network information is “169.254.26.1”. With this, even if a connection terminal destination of the first camera 5 is changed (for example, from the first camera terminal 20a on the left side surface 22 to the second camera terminal 20b on the right side surface 24), it is unnecessary to reset the first network information. Further, even if a connection terminal destination of the second camera 6 is changed (for example, from the third camera terminal 20c on the left side surface 22 to the fourth camera terminal 20d on the right side surface 24), it is unnecessary to reset the second network information.

According to the embodiment, the robot 10 includes the first camera terminal 20a and the second camera terminal 20b to which the same first network information is set. The robot 10 includes the third camera terminal 20c and the fourth camera terminal 20d to which the same second network information is set.

With this, it is possible to connect the first camera 5 by selecting either the first camera terminal 20a or the second camera terminal 20b at a position suitable for work. Further, it is possible to connect the second camera 6 by selecting either the third camera terminal 20c or the fourth camera terminal 20d at a position suitable for work.

Furthermore, even if the first camera 5 is connected to either the first camera terminal 20a or the second camera terminal 20b, it is possible to continue work without performing complicated resetting work of changing the first network information. Also, even if the second camera 6 is connected to either the third camera terminal 20c or the fourth camera terminal 20d, it is possible to continue work without performing complicated resetting work of changing the second network information.

Although the invention has been described with reference to the embodiment, the technical scope of the invention is not limited to the scope described in the above embodiment. It is obvious to a person skilled in the art that various modifications or improvements may be made to the above embodiment. It is obvious from the description of the scope of the appended claims that a form with such modification or improvement can also be included in the technical scope of the invention. The invention may be provided as a robot system having a robot and a control device or the like separately, may be provided as a robot including a control device or the like therein, or may be provided as a control device.

The entire disclosure of Japanese Patent Application No. 2017-160893, filed Aug. 24, 2017 is expressly incorporated by reference herein.

What is claimed is:

1. A robot system comprising:
a robot; and
a first network device,
wherein the robot includes
a first network controller including a first network terminal configured to connect to the first network device, and
a second network controller including a second network terminal configured to connect to the first network device, and
wherein first network information is set in the first network controller and the second network controller.

2. The robot system according to claim 1,
wherein the first network device is a camera.

3. The robot system according to claim 1,
wherein the robot includes
a third network controller including a third network terminal configured to connect to a second network device, and
a fourth network controller including a fourth network terminal configured to connect to the second network device, and
wherein second network information different from the first network information is set in the third network controller and the fourth network controller.

4. The robot system according to claim 3,
wherein the first network device and the second network device are stereo cameras.

5. The robot system according to claim 3,
wherein the first network terminal and the third network terminal are disposed on a first surface of a casing of the robot and the second network terminal and the fourth network terminal are disposed on a second surface different from the first surface of the casing of the robot.

6. The robot system according to claim 5,
wherein the first network device and the second network device are stereo cameras.
